(19) United States
(12) Patent Application Publication
(10) Pub. No.: US 2003/0139965 A1
(43) Pub. Date: Jul. 24, 2003

(54) Method for evaluating corporate network users knowledge level through an on-line query system

(75) Inventors: Lucas Trigos, Buenos Aires (AR); Raul Francisco Pinero Pacheco, Buenos Aires (AR)

Correspondence Address: Leopold Presser, Esq., Scully, Scott, Murphy & Presser, 400 Garden City Plaza, Garden City, NY, 11530, US

(73) Assignee: LATIN COMMODITIES S.A., BUENOS AIRES (AR)

(21) Appl. No.: 10/055,703

(22) Filed: Jan. 22, 2002

(51) Int. Cl. G06F 17/60

(52) U.S. Cl. 705/11

(57) ABSTRACT

The present invention is referred to a method for creating an on-line evaluating communication between the human resources office of a company and its personnel, for carrying out periodic evaluations of the personnel's knowledge level on determined corporate topics, without abandoning the respective workstations.

### FIELD OF THE INVENTION

The present invention is referred to a new method for carrying out an evaluation of the personnel knowledge level on certain specific corporate topics by means of the interaction of the corporate network users with an on-line query system. This is particularly useful for great companies, a Bank for example.

The present method can be practiced by means of generating an evaluating communication between the company's personnel manager and the employees through the use of the company Intranet or, if possible, also by means of the Internet, using the employee's workstation as a recipient of the on-line queries system.

Particularly, the present invention is referred to a method for carrying out a personnel knowledge level evaluation through generating a communication between the personnel manager and the corporate network users. Said communication comprises the intervention of the corporate network users in an on-line query system through which evaluating the employee's knowledge level on certain corporate topics based on the result of this survey is possible.

The general application field of the present invention is checking the knowledge level of the human resources of a company through the corporate Intranet or Internet, involving the use of software installed in the corporate network server for dialoguing with the user's workstation. A communication among the corporate personnel department and the network users is allowed, for achieving two main objectives: evaluating the knowledge level of the employees in certain corporate topics, and creating an incentive system through which the employees will be interested in taking training courses offered by the company as a concrete possibility of obtaining a promotion.

### BACKGROUND OF THE INVENTION

In accordance with the inventor's knowledge, there are no traces in the prior art of a method for establishing an online employees evaluation system through an on-line query system using the corporate Intranet or through the Internet. These kinds of systems may involve the whole list of staff of a company through which the company will be able to evaluate the following:

the employees' knowledge level on determined specific corporate topics;

the effectiveness of the training courses offered to their employees;

the type of courses needed based on the analysis of the answers obtained in the previous surveys;

qualifying the employee's level for deciding promotions and/or reorganizations.

It is known in the art that enormous amounts of money are usually spent in many companies for organizing and giving training courses to their personnel. Training and/or qualifying the personnel on determined specific corporate topics are the basic and main mission of these courses. For example, in the case of Banks, training courses on different financial products offered to their clients (for example, evaluation of investment options, etc.) are constantly offered to the personnel. The whole staff of a predetermined sector usually attends these kinds of courses without previously evaluating the differences in the knowledge level between people of said sector.

There are no known accurate on-line methods in the prior art for evaluating personnel allowing to the company to determine the type of courses needed for a specific person or sector, thus optimizing the training resources dedicated to this task. Indeed, giving inappropriate unnecessary courses to a person achieves several negative effects:

a) unnecessarily separates that person of their tasks for attending the course;

b) personnel is not motivated by an unnecessary training course, money spent is lost, and a sensation of being losing the time remains;

c) Once the course is finished, the personnel will be incorrectly classified since an excellent qualification will be obtained and the real training level would not determined.

Once the course is concluded, an evaluation of the personnel is usually carried out in most companies with invalid results since many people who have attended said course did not need it but rather they required another type of training course not given.

The proposed system has been developed for overcoming the above cited problems, consisting basically on carrying out an on-line query system comprising of a set of questions directly sent to the employee's workstation. Said concise, well-addressed questions should be replied without abandoning the workstation, allowing to the human resources office to carry out a precise evaluation on what type of courses each person needs based on the analysis of the results of this online consultation.

These questions can be sent with or without previous warning to the employee, through the corporate Intranet, or also from a remote center, via Internet.

Unlike to the well-known evaluation systems requiring from the employee to abandon the workstation, the present invention purposes an evaluation while the user is working on his workstation. The proposed objective is achieved through a network software allowing the appearance in the user monitor a series of questions that the employee should answer in a predetermined lapse of time. Once questions are answered, the answers are directed to a processing center for automatically evaluating them based on predetermined parameters. Evaluation reports on the survey's results will be issued allowing to the human resources manager to reach to conclusions on the necessary courses to be given in the near future, future promotions, etc.

In accordance to the inventor's knowledge, and the information obtained in different patent searches carried out in different patent databases, there are no known on-line personnel evaluation systems allowing automatic evaluations of the training level of the personnel through the corporate Intranet and issuing evaluation reports from said on-line surveys.

### BRIEF DESCRIPTION OF THE INVENTION

The present invention is referred to a method for creating an on-line evaluating communication between the human resources office of a company and its personnel, for carrying out periodic evaluations of the personnel's knowledge level on determined corporate topics, without abandoning the respective workstations.

The evaluation can be carried out for a specific user, for a group of them or for the whole list of staff, and the results obtained by the server of this network may be used for issuing a detailed and statistical report of the answers obtained.

The purposed system comprises two software programs: CLIENT software and ADMINISTRATOR software, using a TCP/IP communication network over a Windows(*) platform.

For developing the purposed system, the programming environment chosen was Delphi 6.0; for developing the database structure, MS-SQL data Server 7.0(*) has been used.

The main functions of the system are:

1) Keeping the corporate network user's information registered in the corporate database in accordance to the application type. For example: user file number, name and last name, security level, access password, etc.

2) Sending a survey to the network users connected to the network server assigning a fixed amount of time for replying them and a punctuation associated to each answer.

3) Issuing a statistical report, analyzing the obtained answers, maximum point, minimum point, average and standard deviation. Results may be classified by users, sectors, or for the whole list of staff.

4) Based on the answers obtained, the next needed courses topics may be determined, based on the topics for which more incorrect answers have been obtained.

5) Sending general corporate information to all of the network users.

### BRIEF DESCRIPTION OF THE FIGURES

FIG. 1 is a diagrammatical scheme illustrating the composition of the proposed system.

FIG. 2 illustrates a diagram of the CLIENT program structure.

FIG. 3 illustrates, in another diagram, the communication structure between the CLIENT software and the ADMINISTRATOR software, finally:

FIG. 4 is another diagram, similar to the previous ones, where the ADMINISTRATOR program is illustrated.

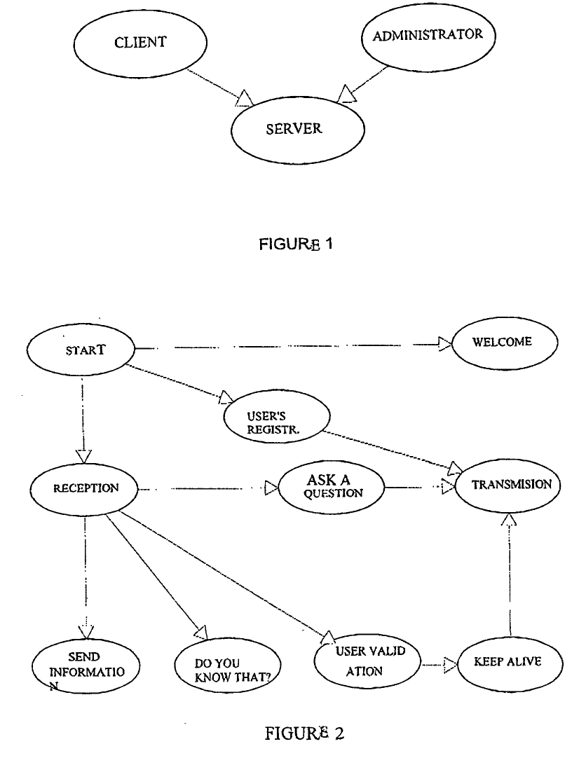

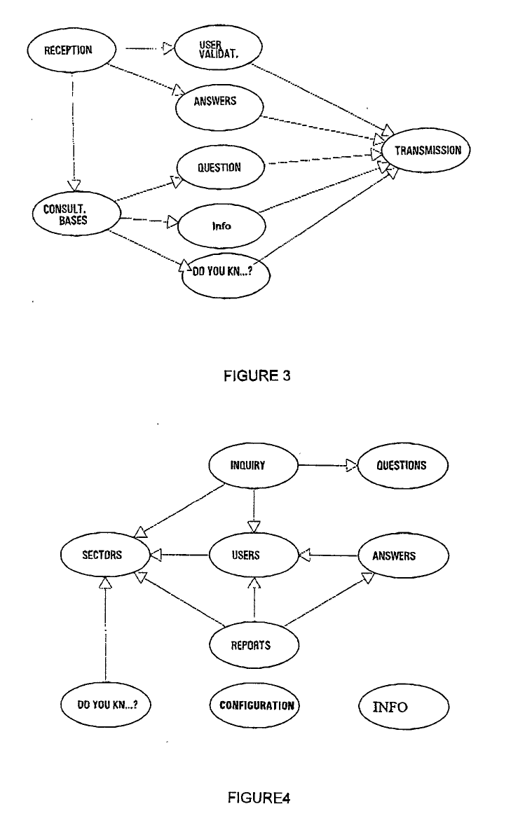

### DETAILED DESCRIPTION OF THE INVENTION

Firstly, a brief description of main features of the CLIENT program is described below, comprising the following modules (see FIG. 2):

Start: calls the Welcome module, shooting the user's validation module and activating the reception.

Welcome: presents the animation of a character called “Dixie Enterprise” together with the final reminding message configured by the administrator program.

User's registration: requests the user's identification number and password, once received these data is sent to the transmission module.

Reception: Activates the “listening” mode in the TCP-IP port of the user's computer for receiving information from the program server. Once received and decoded, it calls to the corresponding module for their processing.

Ask a Question: visualizes the question received from the reception module, waits for the time assigned, and sends the user's answer to the transmission module.

Transmission: receives information of the different modules, codifying it and sending it to the program server.

Send Information: visualizes any text configured in the administrator program.

Do you know that?: user's training information is shown in the user's screen. If the user accepts the complete information on a certain training topic is developed.

User validation: receives the user's password acceptance command from server calling to the “Keep alive” module.

Keep Alive: sends to the transmission module a command informing the server that certain user is connected to the system under conditions for receiving information.

Data processing is carried out using three different Windows tasks: transmission, reception and visualization of animations and the user interface.

Animations are graphic files executed in the CLIENT program; the character of Dixie Enterprise sometimes works as an interface between the user and the server program. The character warns to the user of any server system requirement, either connection or the arrival of some new question.

Animations could be enumerated in the following way:

Program begin

leave screen

appears in the screen

close program

a question approaches

appears a “Do you know that?”

help requested

stands by in the screen

correct answer

failed answer

Installation in the user's PC is carried out through a special software called InstallShield, this software guides the user through the installation steps, installing the application client in the preset directory.

The minimum system requirements are: Windows 9x, NT, ME or 2000 (*), 10 Mb of disk space and TCP-IP network connection with server visibility.

The user executes Dixie Enterprise loading it in the system, having the option of maintaining it hidden or visible, depending on his preference.

Surveys:

In the moment a survey is sent to the user workstation, an animation appears in the screen warning to the user that the survey should be answered. In that moment the user can choose to answer the question later. In this case, the system puts the survey on hold for this user. Once the user accepts the survey, a window appears in the center of the monitor with the first question of the survey, and the user has a certain time to respond the question after which the window disappears. This procedure is repeated with several questions until the survey arrives to its end. Once the survey is finished, the answers are registered in the database for its later processing and the system is kept in an on-hold state waiting for a new survey.

Do You Know That?:

The user may receive help, by maintaining active the “Do you know that?” option. This option allows the user to learn about certain corporate topics, which will be included in future surveys. The character of Dixie Enterprise appears in the user screen offering help and deploying a synthesis of certain corporate topic. If the user wants to see the entirety of the topic appeared, a cookie shown in the center of the screen should be clicked.

Also, the CLIENT program works as server and receiver of the information sent by the ADMINISTRATOR program, presenting the following modules:

Consulting bases: it is executed as a separated task from the main task once a time every 30 seconds for determining the process to be called: a survey, sending information or Do you know that?.

Questions: if there is a valid question for a connected user and the time assigned to this question is in a range that the administrator assigns as valid (inside a certain date), these questions are copied in the CLIENT program.

Information: If there is information to be sent to all the connected users, the CLIENT program does.

Do you know that? Once a time each n minutes, configured by the ADMINISTRATOR program, pieces of information dedicated to the connected users training are sent.

Finally, the modules of the ADMINISTRATOR program consist of:

User: system users discharges, drops and amendments divided in 5 different levels, each user will be able to discharge a new user only if the new user belongs to an inferior level.

Answers: visualizes answers obtained from a certain user, sector, or survey.

Reports: visualizes or prints detailed or statistical reports from the obtained answers of a certain survey, user or sector.

Questions: discharges, drops and modifications of survey answers chart.

Groups: discharges, drops and modifications of sectors chart where the registered users belongs.

Configuration: general parameters of the system: quantity of minutes for the “Do you know that” option, waiting seconds during transmission, waiting during reception, etc.

Information: discharges, drops and modifications of the general information chart for all the connected users of the system.

Do you know that?: discharges, drops and modifications of the “Do you know that?” chart for a certain sector.

Based on the previously explained features, the present invention is referred to a method for generating an evaluating communication with a corporate network user through an on-line query system, comprising the following stages:

1) connecting to the corporate Intranet or Internet a server in whose RAM memory a predetermined USER software is stored achieving the execution of the following command:

connecting to a corporate network the user terminal or workstation in whose RAM memory a software program is stored whose functional characteristics are the following:

is auto executed while the operating system is loaded,

is kept in a background mode, detecting the workstation connection,

when said workstation is connected, a communication between said workstation and said software is established updating the status and information and sending the following data:

a) a warning statement that the workstation is connected.

b) checks up whether there is a pending question for this user;

c) new questions are entered with the required schedules,

d) keep-alive status (maintaining the communication in active state), no “listening” ports are opened, once data is updated is kept updated for 30 seconds and the administrator identifies a connected user in a “waiting” state.

Alternatively the present invention is referred to a method for establishing an evaluating communication with a corporate network user consisting of:

a) Connecting a central system administrator to a corporate Intranet in whose RAM memory a software program is stored for establishing a remote communication with CLIENT programs;

b) The ADMINISTRATOR program controls whether the server client is communicated to the Intranet;

c) A message to the CLIENT program is sent with a question on a specific topic;

d) The user replies to said question and sends the answer to the central server;

e) The central server controls the answer sent from the server user against the one stored in the memory of the system registering the total quantity of correct and incorrect results in a database.

The central server carries out a statistical analysis of the answers, emitting a report on the quantity of incorrect questions, and the kind of topics on which future training must be based, determining which sector or employee needs a training or may be promoted, etc. Said report may be accessed by the administrator through a menu where he will be able to select the survey, the user, or the group of users for which the report is required. Based on this election the administrator will also be able to see statistical information in accordance to the purposed range: user, group, branch, and area, general. The statistical data obtained are Pmin, Pmax, Average, and Standard Deviation.

The purposed system works interacting with a database including several charts for handling the system, for example a chart of users, of questions, of answers, a chart of “do you know that?”, between other functionalities. There are also several charts specifying different groups of users to which a survey is directed, the branches where the questions will be sent, etc.

Basically, the proposed system presents two basic functions: the evaluation of the corporate network users' knowledge level, through an on-line query system; and the training of the network users.

The whole system is supported by two programs, the ADMINISTRATOR's program and the CLIENT program, using the SQL server as a link or nexus between both programs. The ADMINISTRATOR program keeps data in the SQL charts, reads data of those charts and in function of that fact a certain task is executed, for example, a question is sent to a user or a group of users, a “do you know that?” is sent, etc. Different types of questions can be incorporated in the surveys: multiple choice, fill in the blanks, etc.

When the person in charge of the system, called the “administrator”, enters a question in a survey, several correct answers for this question should be entered. Example: Who was the first president of America?, the answer is George Washington, but all the possible correct answers for that question must be entered since the software can only make a text level comparison between the user's answer and the correct answer loaded in the system. The system does not have the “intelligence” of interpreting that if the user answers “G. Washington” means George Washington.

Processing questions to be answered by a multiple choice system is simpler than the previous case, allowing questions with multiple answers, for example: mark 3 of the following ten monuments which are considered as “wonders of the world”.

This system also allows the assignment of predetermined punctuation to the survey's answers including negative punctuation for certain answers. For example, if a survey includes a question for: who was the first president of America?, a probable rating may be: George Washington: 100 points, Abraham Lincoln: 80 points, George Clooney: −50 points.

The ADMINISTRATOR software program is in charge of managing the whole system: loading query questions, establishing user's chart with hierarchies, including for example, five different hierarchies, being hierarchy N° 5 assigned to the system administrator, N° 4 for the General Manager, N° 3 for the Regional Manager, N° 2 for the Branch Manager, and finally the N° 1 for the employees. The system is programmed so that in a hierarchical organization, as for example a Bank, each manager can evaluate the people he has in charge. For example, in the case of a Regional manager, he can only evaluate the personnel of their region; a Branch Manager can only evaluate the personnel of their branch, etc. Moreover, managers have only access to the reports corresponding to surveys sent to the people he has in charge. For example, the Manager of a certain branch cannot see the results of the survey of another branch.

Questions are loaded in the ADMINISTRATOR's program, being the survey the information unit of this system, not the questions. The survey is composed of several questions that can be of different types. Once the date and time of a survey is determined, it will appear in the screen of the users connected to the network at this time, since the CLIENT system permanently reads the base, for example, every 30 seconds.

CLIENT program constantly reads the database detecting when a survey for a user is ready, downloading the survey in the user's workstation, controlling the clock, and showing the survey to the user once the pre set time arrives. Showing a survey means showing the sequences of questions that compose the survey, according to the type of questions. A predetermined time is assigned to every question.

Another possibility of the purposed system consists on allowing the user to defer the answer considering the potential situation that the survey arrives exactly in the moment that the user is assisting a client. Ending said sequence would mean that the user decides to answer the survey later, and those answers are loaded in the server.

Finally, the ADMINISTRATOR software basically reads two charts, correct answers against each user's answers, to establish each user's punctuation and later to calculate statistical data. Basically, the average of a certain survey, the maximum point, the minimum point and the standard deviation may be calculated. There are four basic statistical data for evaluation purposes. Those calculations are made by the ADMINISTRATOR software in any moment once the survey is finished.

Another distinctive characteristic of the proposed system is that the surveys have an expiration time because the user can postpone the answer of a survey, but can not postpone it indefinitely. The allowed delaying time for replying a survey is determined by the system. Replying a survey can be postponed but with a certain limit, for example, one day.

With the purposed system a predetermined survey may be mandatory, in that case the Manager may determine that certain survey cannot be postponed. If a user cannot answer, he has to clarify the reasons. The ADMINISTRATOR software also determines the number of users to which a survey is directed.

Although it was determined that as a result of the surveys four statistical parameters can be calculated, this is not limitative that the results can be used with any other purpose.

The CLIENT program makes these things dialoguing with the data base charts. “Do you know that?” function is an option for the user because the idea is training users on certain corporate topics and not to bother them. If users know that topics included in the “do you know that?” are topics possibly included in future surveys, will want to read and learn about it and it is also a training tool for the company's management.

Animations represent actions and those actions in the proposed system are limited. If the user responds correctly, and the user's answer coincide with the maximum punctuation answer registered in the system, a special animation for a correct answer is shown, if an intermediate punctuation is obtained, anything is shown. The system may show the result of the survey to the user. This is also customizable, for example the result of a survey can be shown to the user if for any reason the Bank is interested in doing so.

The client software has to have visibility with the system server for which TCP/IP network should be used, such as Internet, Lan, or any other one adapted to the visibility necessities. What is not allowed is a visibility between the ADMINISTRATOR and the CLIENT system.

What is claimed is:

1. Method for generating an evaluating communication with a corporate network user through an on-line query system, comprising the following stages:
1) connecting to the corporate Intranet or Internet a server in whose RAM memory a predetermined USER software is stored achieving the execution of the following command:
connecting to a corporate network the user terminal or workstation in whose RAM memory a software program is stored whose functional characteristics are the following:
is auto executed while the operating system is loaded,
is kept in a background mode, detecting the workstation connection,
when said workstation is connected, a communication between said workstation and said software is established updating the status and information and sending the following data:
e) a warning statement that the workstation is connected.
f) checks up whether there is a pending question for this user;
g) new questions are entered with the required schedules,
h) keep-alive status (maintaining the communication in active state), no “listening” ports are opened, once data is updated is kept updated for 30 seconds and the administrator identifies a connected user in a “waiting” state.

2. Method for generating an evaluating communication with a corporate network user through an on-line query system, in accordance to claim 1, wherein the corporate network is the Intranet network of a Bank.

3. Method for generating an evaluating communication with a corporate network user through an on-line query system, in accordance to claim 1, wherein the evaluation can be carried out for a specific user, for a group of them or for the whole list of staff, and the results obtained are used for issuing a detailed and statistical report.

4. Method for generating an evaluating communication with a corporate network user through an on-line query system, in accordance to claim 3, wherein the statistical report includes the calculation of the following parameters: maximum point, minimum point, average and standard deviation.

5. Method for generating an evaluating communication with a corporate network user through an on-line query system, in accordance to claim 1, wherein said software program stored in the corporate server comprises an ADMINISTRATOR software and a data base for registering query results and clients data, and the software program stored in the user workstation is a CLIENT software, using a TCP/IP communication network over a Windows(*) platform.

6. Method for generating an evaluating communication with a corporate network user through an on-line query system, in accordance to claim 5, wherein said CLIENT and ADMINISTRATOR software programs have been programmed using Delphi 6.0, and said data base has been developed using MS-SQL data Server 7.0.

7. Method for generating an evaluating communication with a corporate network user through an on-line query system, in accordance to claim 5, wherein said database stores the following user's data: user file number, name and last name, security level, access password.

8. Method for establishing an evaluating communication with a corporate network user consisting of:
a) connecting a central system administrator to a corporate Intranet in whose RAM memory a software ADMINISTRATOR program is stored for establishing a remote communication with CLIENT programs;
b) the ADMINISTRATOR program controls whether the server client is communicated to the corporate Intranet;
c) a message to the CLIENT program is sent with a question on a specific topic;
d) the user replies to said question and sends the answer to the central server;
the central server controls the answer sent from the server user against the one stored in the memory of the system registering the total quantity of correct and incorrect results in a database.

9. Method for generating an evaluating communication with a corporate network user through an on-line query system, in accordance to claim 8, wherein the corporate network is the Intranet network of a Bank.

10. Method for generating an evaluating communication with a corporate network user through an on-line query system, in accordance to claim 8, wherein the evaluation can be carried out for a specific user, for a group of them or for the whole list of staff, and the results obtained are used for issuing a detailed and statistical report.

11. Method for generating an evaluating communication with a corporate network user through an on-line query system, in accordance to claim 10, wherein the statistical report includes the calculation of the following parameters: maximum point, minimum point, average and standard deviation.

12. Method for generating an evaluating communication with a corporate network user through an on-line query system, in accordance to claim 8, wherein said software program stored in the corporate server comprises an ADMINISTRATOR software and a data base for registering query results and clients data, and the software program stored in the user workstation is a CLIENT software, using a TCP/IP communication network over a Windows(*) platform.

13. Method for generating an evaluating communication with a corporate network user through an on-line query system, in accordance to claim 12, wherein said CLIENT and ADMINISTRATOR software programs have been programmed using Delphi 6.0, and said data base has been developed using MS-SQL data Server 7.0.

14. Method for generating an evaluating communication with a corporate network user through an on-line query system, in accordance to claim 12, wherein said database stores the following user's data: user file number, name and last name, security level, access password.
